(19) United States
(12) Patent Application Publication
(10) Pub. No.: US 2008/0067885 A1
(43) Pub. Date: Mar. 20, 2008

(54) Permanent magnet machine

(75) Inventor: Freddy Magnussen, Vasteras (SE)

Correspondence Address: VENABLE LLP, P.O. BOX 34385, WASHINGTON, DC, 20043-9998, US

(73) Assignee: ABB RESEARCH LTD., Zurich (CH)

(21) Appl. No.: 11/522,469

(22) Filed: Sep. 18, 2006

(51) Int. Cl. H02K 21/12; H02K 1/00; H02K 1/28; H02K 1/12

(52) U.S. Cl. 310/156.38; 310/216; 310/218; 310/156.45; 310/259; 310/156.46; 310/260; 310/254

(57) ABSTRACT

A permanent magnet machine comprises a stator having plurality of slots between a plurality of stator teeth, which are interconnected by a yoke, wherein concentrated windings are provided in the plurality of slots. A rotor is provided with a plurality of permanent magnets creating a plurality of magnetic poles. By giving the machine a relation between the number of slots and the number of poles that is given by Q=p+−2, wherein Q is the number of slots and p is the number of poles, low ripple torque and high torque density are obtained, particularly for servo applications.

### FIELD OF INVENTION

The present invention relates generally permanent magnet machines and more particularly to a machine having improved performance.

### BACKGROUND

PM machines using concentrated windings are gaining in popularity at the expense of distributed windings in various applications, mainly due to cost savings. The result is an increased amount of parasitic effects like ripple torque, alternating magnetic fields in the rotor, unbalanced radial forces and magnetic noise.

Prior art machines of this kind are described in the article “Permanent-Magnet Brushless Machines With Unequal Tooth Widths and Similar Slot and Pole Numbers” by Dahaman Ishak, Z. Q. Zhu, and David Howe, IEEE Transactions on Industry Applications, Vol. 41, No. 2, March/April 2005.

### SUMMARY OF THE INVENTION

An object of the present invention is to provide a permanent magnet machine of the kind initially described having improved performance.

The invention is based on the realisation that a specific combination of the number of poles and slots results in increased performance.

According to the invention a permanent magnet machine is provided comprising a stator having plurality of slots between a plurality of stator teeth, which are interconnected by a yoke, wherein concentrated windings are provided in the plurality of slots, a rotor having a plurality of permanent magnets creating a plurality of magnetic poles, wherein the relation between the number of slots and the number of magnetic poles is given by Q=p+−2, and wherein Q is the number of slots and p is the number of magnetic poles.

Thus a permanent magnet machine with concentrated windings is provided, which thanks to the combination of number of poles and slots, in a preferred embodiment 10 and 12, respectively, exhibits a low ripple torque and high torque density, particularly for servo applications. The electrical frequency is also moderate for normal servomotor operation, up to about 500 hertz, which is advantageous for low core losses and good control accuracy.

In a preferred embodiment, the permanent magnets have a cross-sectional shape with a planar surface facing radially inwards and a convex surface facing radially outwards. The permanent magnet cost can thereby be reduced compared with a traditional servomotor, since the modular topology requires no complicated shape of the permanent magnets in order to reduce the ripple torque.

In a further preferred embodiment, the end segments of the stator are made of soft-magnetic composite (SMC) iron powder, which extends the effective length of the stator, further increasing the torque density or rated power. Also, since the cross-sectional shape of the end tooth is very well suited for the end turn of the winding, wherein the cross-sectional shape of an end segment tooth is convex on the side facing the stator end, the thermal conduction is improved as compared to prior art machines, wherein the air between the end tooth and the end of the winding acts as a thermal insulator.

In a further preferred embodiment, the stator teeth are made of grain oriented silicon iron. The motor can thereby achieve better magnetic performance regarding overload capability and core losses.

In yet a preferred embodiment, the stator teeth are at the base thereof interconnected by one single yoke part so as to form a circular periphery. A separate housing is then not necessary. Instead, the outer periphery of the yoke part acts also as a house. In order to facilitate manufacturing, the yoke part is preferably made of silicon iron or iron powder.

Further preferred embodiments are defined by the dependent claims.

### BRIEF DESCRIPTION OF DRAWINGS

The invention is now described, by way of example, with reference to the accompanying drawings, in which:

FIG. 1 is an overall view of a machine according to the invention;

FIG. 2 is a cross-sectional view of the machine shown in FIG. 1;

FIG. 3 shows the stator winding configuration referring to slots shown in FIG. 2;

FIG. 4 is a partially cut-way view of a stator comprised in the machine according to the invention;

FIG. 5 shows and end segment used in the machine according to the invention;

FIG. 5a shows a cross-sectional view of the end segment shown in FIG. 5;

FIG. 6 is a detailed cross-sectional view of a permanent magnet of the rotor in a machine according to the invention;

FIG. 7 shows waste areas of a prior art machine compared with the waste areas of a machine according to the invention; and

FIG. 8 is a cross-sectional view of an alternative embodiment of a machine according to the invention.

### DETAILED DESCRIPTION OF PREFERRED EMBODIMENTS

In the following a detailed description of preferred embodiments of the present invention will be given. These embodiments are also described in the article “Parasitic Effects in PM Machines with Concentrated Windings” by Freddy Magnussen and Heinz Lendenmann, Industry Applications Society Annual Meeting, 2005 IEEE, ISBN: 0-7803-9208-6, which document is incorporated herein by reference.

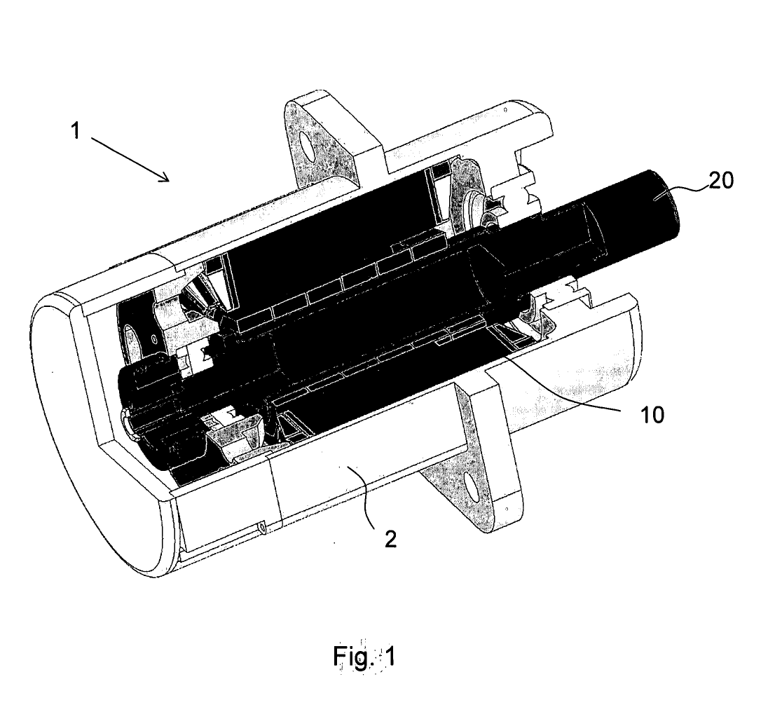

In FIG. 1 a permanent magnet (PM) machine 1 according to the invention is shown, wherein part of the machine housing, stator, and rotor has been cut away. The housing 2 houses the essentially cylindrical stator 10, which in turn surrounds the rotor 20, as is conventional.

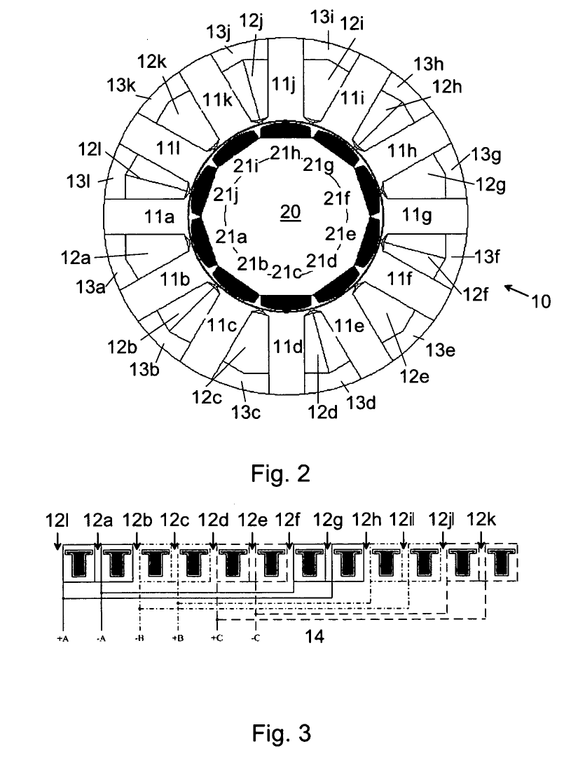

A cross-sectional view of the stator 10 and rotor 20 is shown in FIG. 2. The stator, which is made up of stacked laminations, comprises twelve teeth 11a-l of silicon iron having slots 12a-l there between. The teeth are at the base thereof interconnected by yoke parts 13a-l so as to form a circular periphery. In order to facilitate manufacturing, the yoke parts are preferably made of silicon iron or iron powder as will be explained below.

Stator windings 14 made up of electrically conductive wires, preferably made of copper, are wound about each of the teeth 11a-l. The stator winding configuration is shown in FIG. 3, wherein the windings of the three phases A, B, and C are shown. From the figure it is seen that the windings of each phase are wound about adjacent teeth. This means that the windings of phase A are provided in slots 121, 12a, 12b and 12f, 12g, 12h. The windings of phases B and C are provided accordingly in the slots.

The rotor 20 is provided with ten permanent magnets 21a-j equally spaced about the rotor periphery. The permanent magnets each have a planar side facing radially inwards and a curved side facing radially outwards towards the teeth and slots. This provides for a cost efficient manufacturing of the magnets while maintaining sufficient performance. Thus, permanent magnet costs can be reduced by up to 50% compared with a traditional servomotor, because the modular topology does not require a complicated shape of the permanent magnets in order to reduce the ripple torque.

A machine according to the invention has the following relation between the number of slots and the number of poles:

Q=p+−2

wherein Q is the number of slots and p is the number of poles. The above-described machine has ten poles and twelve slots, with a number of slots per pole per phase equal to 0.4. This pole-slot combination provides a cost effective manufacturing, low ripple torque and high torque density, particularly for servo applications. The electrical frequency is also moderate for normal servo-motor operation, up to about 500 hertz, which is advantageous for low core losses and good control accuracy.

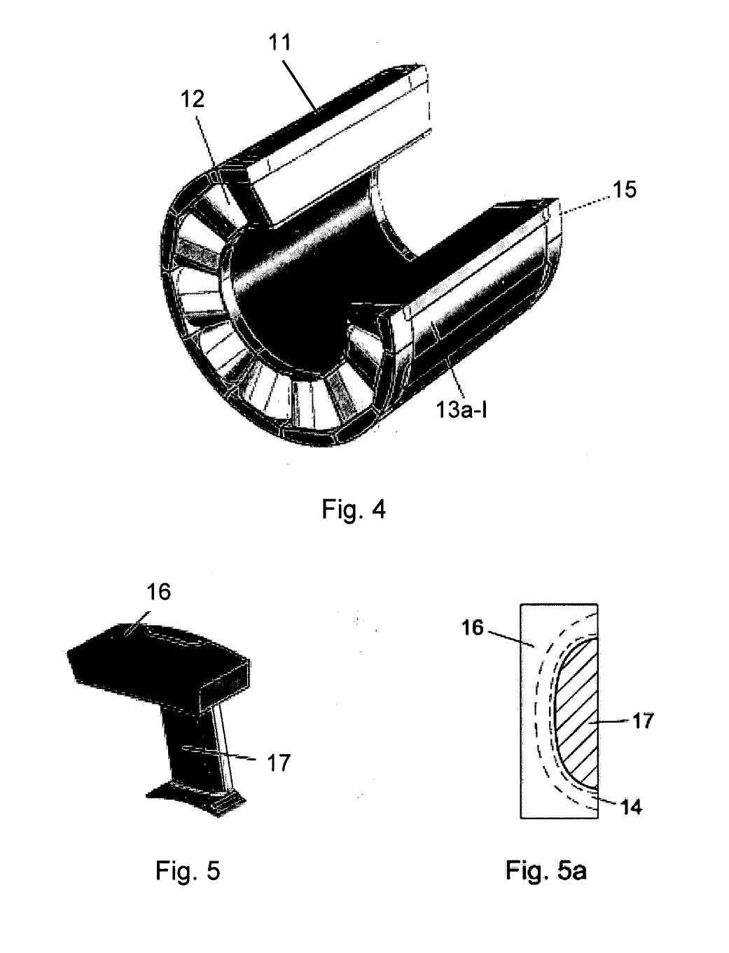

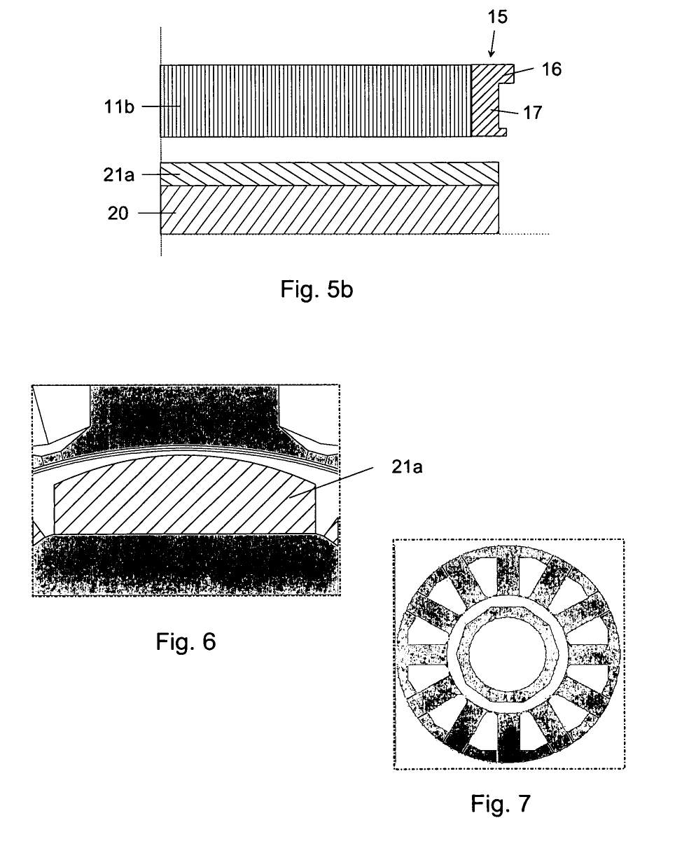

A partially cut-way view of a stator comprised in the machine is shown in FIG. 4. In this figure, end segments 15 are shown provided outside of the laminations making up the bulk of the stator. A perspective view of an end segment 15 is shown in FIG. 5. The yoke portion 16 of the end segment is made of iron powder while the tooth 17 is made of silicon iron.

A cross-sectional view of the end segment of FIG. 5 is shown in FIG. 5a. The section is taken through the tooth 17 from the rotor side. Winding 14 is shown in the figure with dashed lines. It is here seen that the cross-sectional shape of the tooth is convex on the side facing the stator end and is thus very well suited for the end turn of the winding, which is possible thanks to the fact that the end segment is made of iron powder. Also, the thermal conduction between windings and the tooth is very high.

In FIG. 5b a sectional view of part of the machine 1 is shown. Only an end portion of half of the machine is shown—the symmetry line about the central axis of the machine is shown with a dash-dotted line. It is seen from this figure that the properties of the end segment 15 extends the usable length of the stator. In other words, since the area enclosed by the end portion of winding 14, see FIG. 5a, is filled with conductive material, the magnetic field can be active also in this area, increasing the effective torque of the machine.

In FIG. 6 there is shown a cross-sectional view of one of the permanent magnets 21a-j, such as permanent magnet 21a. It is here seen that the cross-sectional shape of the permanent magnet has a planar surface facing radially inwards and a convex surface facing radially outwards. In this way, the permanent magnet cost can be reduced compared with a traditional servomotor, since the modular topology requires no complicated shape of the permanent magnets in order to reduce the ripple torque.

The stator teeth are preferably punched separately, which reduces material waste. The white areas of FIG. 7 show the waste material in an ordinary electric motor production process. By punching the stator teeth individually, i.e., with the stator teeth laminations as separate parts, the teeth can be punched in the same direction. This in turn makes possible to use grain oriented silicon iron instead of the non-oriented material that is normally use. The motor can therefore achieve better magnetic performance regarding overload capability and core losses.

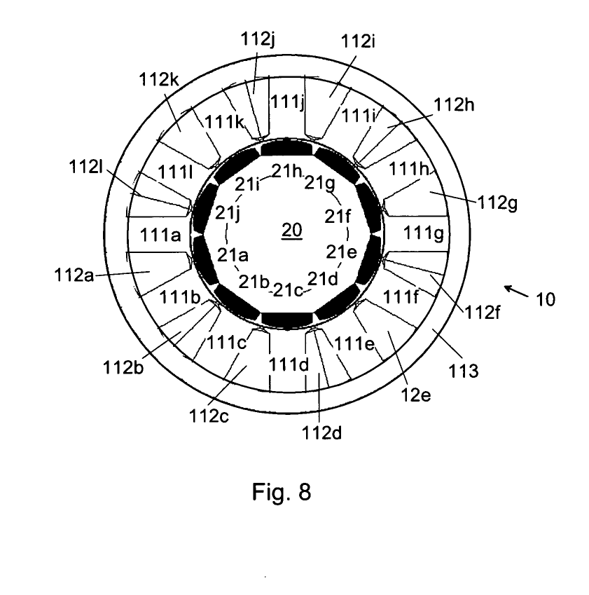

An alternative embodiment of an inventive machine is shown in cross-section in FIG. 8. The stator, which is made up of stacked laminations, comprises twelve teeth 111a-l of silicon iron having slots 112a-1 there between. The teeth are at the base thereof interconnected by one single yoke part 113 so as to form a circular periphery. In order to facilitate manufacturing, the yoke part is preferably made of silicon iron or iron powder.

Preferred embodiments of a machine according to the invention have been described. A person skilled in the art realises that these could be varied within the scope of the appended claims. Thus, the exact shapes of the above described machine parts can be different than the ones shown in the figures without departing from the inventive idea.

1-13. (canceled)

14. A permanent magnet machine, comprising:
a rotor comprising a plurality of permanent magnets creating a plurality of magnetic poles;
a stator surrounding the rotor, the stator comprising
stacked laminations comprising a plurality of stator teeth,
a plurality of slots arranged between the stator teeth,
a yoke interconnecting the teeth,
concentrated windings arranged in the slots, and
end segments arranged at the ends of the laminations, each end segment comprising a tooth having a convex surface on a side facing an end of the stator,
wherein a relationship between the number of slots and the number of magnetic poles is given by
Q=p±2
wherein Q is the number of slots and p is the number of magnetic poles.

15. The permanent magnet machine according to claim 14, wherein the number of slots is 12 and the number of magnetic poles is 10.

16. The permanent magnet machine according to claim 14, wherein the yoke comprises silicon iron or iron powder.

17. The permanent magnet machine according to claim 14, wherein the stator teeth comprise silicon iron.

18. The permanent magnet machine according to claim 1, wherein permanent magnets each have a planar side facing radially inwards and a curved side facing radially outwards.

19. The permanent magnet machine according to claim 1, wherein the number of slots per pole per phase is 0.4.

20. The permanent magnet machine according to claim 14, wherein the machine is a permanent magnet servo machine.

21. The permanent magnet machine according to claim 14, wherein an electrical frequency is up to about 500 Hz.

22. The permanent magnet machine according to claim 14, wherein each stator tooth lamination is a separate part.

23. The pennanent magnet machine according to claim 14, wherein the stator teeth comprise grain oriented material.

24. The permanent magnet machine according to claim 13, wherein the stator teeth comprise grain oriented silicon iron.

25. The permanent magnet machine according to claim 14, comprising one single yoke part.
